(19) United States
(12) Patent Application Publication
(10) Pub. No.: US 2013/0318479 A1
(43) Pub. Date: Nov. 28, 2013

(54) STEREOSCOPIC USER INTERFACE, VIEW, AND OBJECT MANIPULATION

(71) Applicant: Autodesk, Inc., San Rafael, CA (US)

(72) Inventor: Gunjan Porwal, Clementi (SG)

(73) Assignee: Autodesk, Inc., San Rafael, CA (US)

(21) Appl. No.: 13/901,895

(22) Filed: May 24, 2013

Related U.S. Application Data
(60) Provisional application No. 61/651,150, filed on May 24, 2012.

(51) Int. Cl. G06F 3/0481

(52) U.S. Cl. CPC G06F 3/04815
USPC 715/849

(57) ABSTRACT

A method, apparatus, and system provide the ability to interact with a virtual stereoscopic object. A set of sensors is placed adjacent to a stereoscopic viewing area. A stereoscopic object is projected in the stereoscopic viewing area. A user's body part is tracked using the set of sensors. A gesture of the user's body part is determined (based on the tracking). Based on the gesture, an interaction event is actively and dynamically applied to the stereoscopic object.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/651,150, filed on May 24, 2012, by Gunjan Porwal, entitled “Stereoscopic User Interface, View, and Object Manipulation,” attorneys' docket number 30566.491-US-P1.

### BACKGROUND OF THE INVENTION

1. Field of the Invention

The present invention relates generally to three-dimensional (3D) images and displays, and in particular, to a method, apparatus, and article of manufacture for viewing and manipulating stereoscopic 3D (S3D) images in a graphical user interface.

2. Description of the Related Art

Stereoscopy is a method for presenting an illusion of 3D depth from images on a two-dimensional (2D) plane. To create such an illusion, two slightly offset images are presented separately to the left and right eye of a viewer. Various techniques may be used to mechanically present the 3D illusion to a user. Some stereoscopic techniques may require a viewer to wear glasses that combine the images from two offset sources and/or to filter offset images from a single source separated to each eye. Alternatively, in a technique known as autostereoscopy, a lightsource may split the images directionally into the viewer's eyes (without requiring glasses).

Regardless of the technique used to provide stereoscopy, prior art systems have failed to provide the capability to work with and manipulate objects in a stereoscopic 3D environment. Embodiments of the invention present multiple different methodologies to solve such problems.

### SUMMARY OF THE INVENTION

Rotating Stereoscopic Views—Multiple stereoscopic cameras are placed around a designated geographic area/scene. Each camera captures stereographic data from different angles. The user can then select the desired viewing angle and view objects (and the geographic area/scene) stereoscopically.

Object Manipulation in Stereoscopic Mode—A stereoscopic 3D (S3D) object may be moved outside of the viewing area/viewport. Thereafter, the S3D object can still be rotated around its own axis (or a center of the bounding box of the S3D object) by utilizing a virtual pivot that is displayed within the viewing area/viewport.

Stereoscopic Object Handling Interface and Interaction Index—Sensors are placed adjacent to a 3D monitor in a manner to triangulate a user's location. Stereoscopic 3D objects (S3D) are displayed on the 3D monitor and project out from the screen. The user's hand locations (detected by the sensors) are detected and tracked relative to the S3D objects. Based on the gestures of the user's hands, the S3D objects can be manipulated to provide a dynamic real time interaction with virtual objects. In addition, an interaction level index (that is modifiable by a user) can be used to specify the interactivity of the object with respect to the user's hands. Such an interaction level index may define the matter state/phase/viscosity of the virtual object (e.g., solid, liquid, or gas). For example, a high index may specify a solid state for the virtual object such that when the ball is touched, it may bounce/bounce back at a high velocity. In such an example, the index may also represent the spring constant of the S3D objects. Alternatively, the index level may specify a different matter state or the viscosity. For example, the level may represent a viscosity level such that the user's hand can pass through the virtual object as if the virtual object is water/smoke/fire or thicker similar to jelly or oil.

Levels of Stereoscopic 3D—Different content from a 3D stereoscopic scene may be classified into different categories/levels. When playing back the scene, the user can elect to view one or more of the levels of the scene. Such an election may be made for the entire S3D scene such that particular content may/may not be displayed (e.g., violent content). Alternatively, the election may be based on a category mechanism in a viewer's stereoscopic glasses being used to view the S3D scene. In such an embodiment, different viewers wearing glasses with different settings may view different content from the same S3D scene, when the single S3D scene (containing various levels of S3D content) is being displayed simultaneously to all of the viewers.

Using Head-Tracking for Projecting Audio in Lenticular Glasses-Free Stereoscopic Displays—Glasses-free stereoscopic displays use head-tracking mechanisms to keep track of the user so that the display can project stereoscopic images. In lenticular glasses-free displays, the 3D stereoscopic effect can only be seen in limited zones in front of the screen, known as “sweet spots”. By tracking the user, the display can check to see if the user has moved from one sweet spot to another and shift the lenticular lens screen accordingly. Embodiments of the invention integrate directional audio with the display such that the audio stream is automatically directed towards the user as the user moves around. In addition, properties of the audio signal (e.g., the language of the audio, stereo/multichannel, etc.) may be modified based on the position where the user sits.

Stereoscopic User Interface—Upon activation (e.g., via a keyboard control or hotkey), a user interface is displayed to the user in stereoscopic mode. In this regard, the user interface may appear (with glasses or in glasses-free stereoscopic displays) in front of the screen, sideways of the screen or partly in front of the screen and partly sideways. Interaction with the user interface is made possible via a set of sensors that determine the position of the user's hands with respect to the user interface.

Tools for Modification of Stereoscopic 3D Objects and Saving Their Property—2D objects are often projected into stereoscopic 3D (S3D) views. Similarly, S3D objects (having corresponding 2D objects) may also be viewed in a S3D view. Embodiments of the invention store properties of related 2D and S3D objects in separate reference files. Thus, if a 2D object is viewed in a 2D view, any properties viewed are based on the objects 2D properties. However, if the corresponding/related S3D object is viewed in a S3D view, the S3D properties are retrieved from the appropriate S3D reference file and used. Alternatively, changes made in one reference file may be promulgated to the other reference file (e.g., changes made to the properties of a S3D object may be filtered/promulgated to the 2D version of the object). In addition, stereoscopic tools may be used to modify stereoscopic objects (e.g., a virtual stereoscopic paintbrush tool may be used to paint a S3D object). Thus, S3D tools may interact with an S3D object based on a virtual location where the S3D tool “touches” the S3D object.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system used in accordance with one or more embodiments of the invention;

FIG. 3 illustrates an exemplary configuration for capturing multiple views of a scene to enable the rotation of stereoscopic views in accordance with one or more embodiments of the invention;

FIGS. 4A and 4B each illustrate a stereographic display with the same scene viewed in a different angle in accordance with one or more embodiments of the invention;

FIG. 5 illustrates sensors that are used to handle the interaction between stereoscopic objects and the physical user in accordance with one or more embodiments of the invention;

FIG. 6 illustrates the pivot of an object that has been shifted away from the object in accordance with one or more embodiments of the invention;

FIG. 7 shows a temporary shift of a pivot away from an object in accordance with one or more embodiments of the invention;

FIGS. 8A and 8B show an example implementation of utilizing a pivot to rotate an off-screen S3D object in accordance with one or more embodiments of the invention;

FIG. 9 illustrates an example of different levels of stereoscopic 3D in accordance with one or more embodiments of the invention;

FIG. 10 illustrates a top view of a stereoscopic 3D glasses free display in accordance with embodiments of the invention;

FIG. 11 illustrates a user changing his/her position from point A to point B in accordance with one or more embodiments of the invention;

FIG. 12 illustrates a home theater setup that is integrated with a directional audio setup in accordance with one or more embodiments of the invention;

FIG. 13 illustrates a change in audio properties in accordance with one or more embodiments of the invention;

FIG. 14 illustrates a stereoscopic display with a full-screen viewport in accordance with one or more embodiments of the invention;

FIGS. 15 and 16 illustrate a UI that is visible in stereoscopic mode in accordance with one or more embodiments of the invention;

FIG. 17 illustrates the use of a tool for modification of stereoscopic 3D objects and saving their property in accordance with one or more embodiments of the invention; and

FIG. 18 illustrates the logical flow for interacting with a virtual stereoscopic object in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

As described above, various different embodiments provide the ability to work with, visualize, and manipulate objects in an S3D environment. The description below divides some of the potential embodiments into different sections. In addition, a general hardware description is set forth.

### Hardware Environment

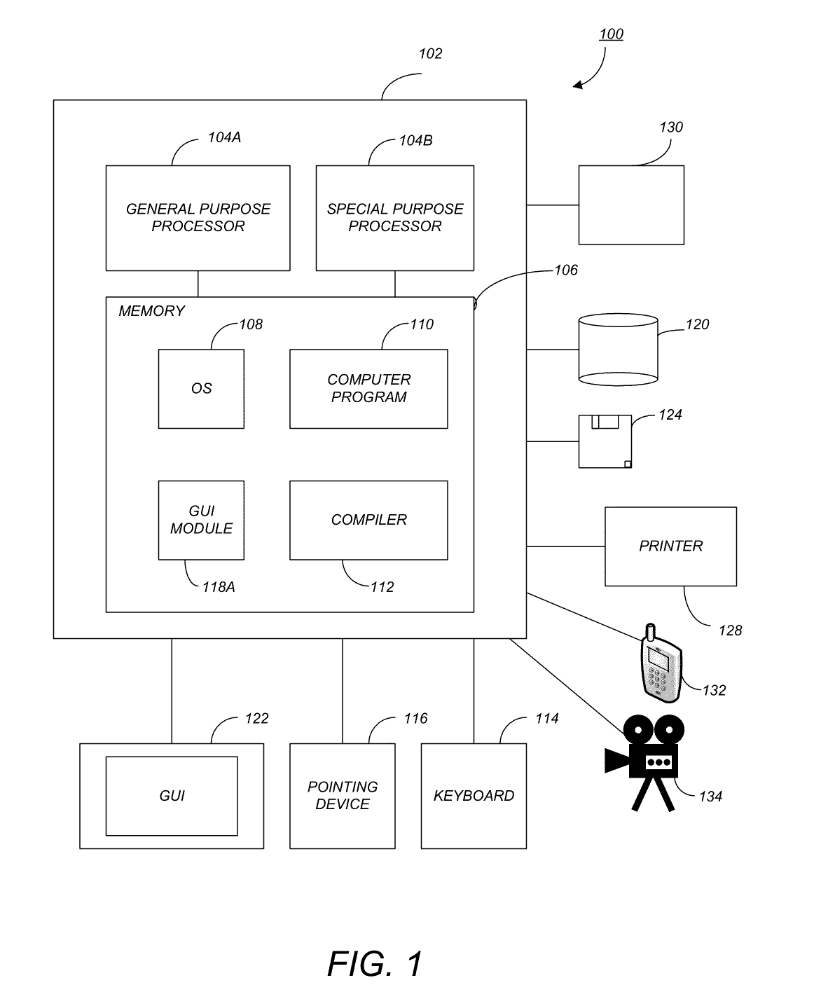

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands.

In various embodiments of the invention, the display 122 is a 3D display device which may comprise a 3D enabled display (e.g., 3D television set or monitor), a head mounted display (e.g., a helmet or glasses with two small LCD or OLED [organic light emitting diode] displays with magnifying lenses, one for each eye), active or passive 3D viewers (e.g., LC shutter glasses, linearly polarized glasses, circularly polarized glasses, etc.), etc. In this regard, any technique that may be utilized to view 3D stereoscopic images is represented by display 122. Further, one or more stereoscopic cameras 134 may be configured to communicate with computer 100 to enable a 3D display on 3D display 122.

The 3D image may be provided through a graphical user interface (GUI) module 118A. Although the GUI module 118A is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 102 may also implement a compiler 112 that allows an application program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, cause the computer 102 to perform the steps necessary to implement and/or use the present invention or to load the program of instructions into a memory, thus creating a special purpose data structure causing the computer to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

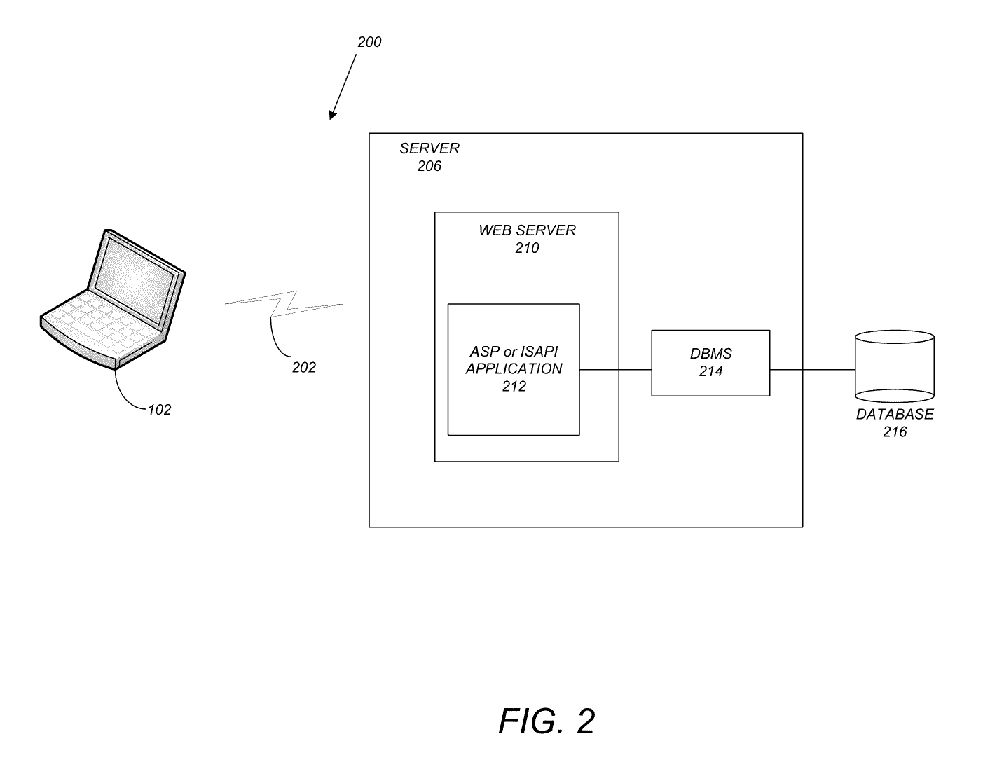

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 102 and servers 206 in accordance with embodiments of the invention.

A network 202 such as the Internet connects clients 102 to server computers 206. Network 202 may utilize ethernet, coaxial cable, wireless communications, radio frequency (RF), etc. to connect and provide the communication between clients 102 and servers 206. Clients 102 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, etc. Further, the software executing on clients 102 may be downloaded from server computer 206 to client computers 102 and installed as a plug-in or ACTIVEX™ control of a web browser. Accordingly, clients 102 may utilize ACTIVEX™ components/component object model (COM) or distributed COM (DCOM) components to provide a user interface on a display of client 102. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT′S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 102 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 102 and 206.

Embodiments of the invention are implemented as a software application on a client 102 or server computer 206. Further, as described above, the client 102 or server computer 206 may comprise a thin client device or a portable device that has a multi-touch-based and/or 3D enabled display capability.

### Rotating Stereoscopic Views

Current stereoscopic views are limited to a single view (i.e., users can only view a single view of a scene). Embodiments of the invention propose a new way to watch stereoscopic videos. Namely, a viewer is allowed to view a stereoscopic display from different angles, choosing to rotate the view as per the user's desires.

Currently, many major sports broadcasts are being covered in stereoscopic 3D. The cameramen covering the broadcast use stereoscopic cameras to cover the presentation. Some recent technological advances also propose to present the broadcasts in holographic views (e.g., via holographic television/broadcasts). Such a broadcast would involve installing an array of cameras around a stadium, capturing images from all of the cameras simultaneously and combining the images in real-time to present a holographic display.

Embodiments of the invention display similar results on a 3D stereoscopic display. Instead of placing normal HD (high definition) cameras around an event (sports complex or music stadium or movie scene), stereoscopic cameras would be placed. These cameras would capture stereoscopic data from different angles and a software application stitches the data in real-time to form a pseudo-holographic representation of the scene. When this scene is displayed on an S3D display, the viewer can see a stereoscopic view of the event, while also having the option to look at the same event from a different angle in stereoscopic mode. The multi-stereoscopic view capability is provided since each frame of the event is available from 360 degrees (or whatever angle has been covered by the movie producer).

Alternatively, the cameras may be placed 180 degrees around the event (such as in a music concert). In such an embodiment, the user has the option to select a rotation of the view and/or select a particular view that is presented from a different angle.

The view selection may be in the form of gesture recognition, or in the form of a new button on the remote control that can help in selecting the angle. Accordingly, the user can see the same event from different angles in repeated viewings (e.g., the user can choose to repeatedly watch the same event but from a different angle each time).

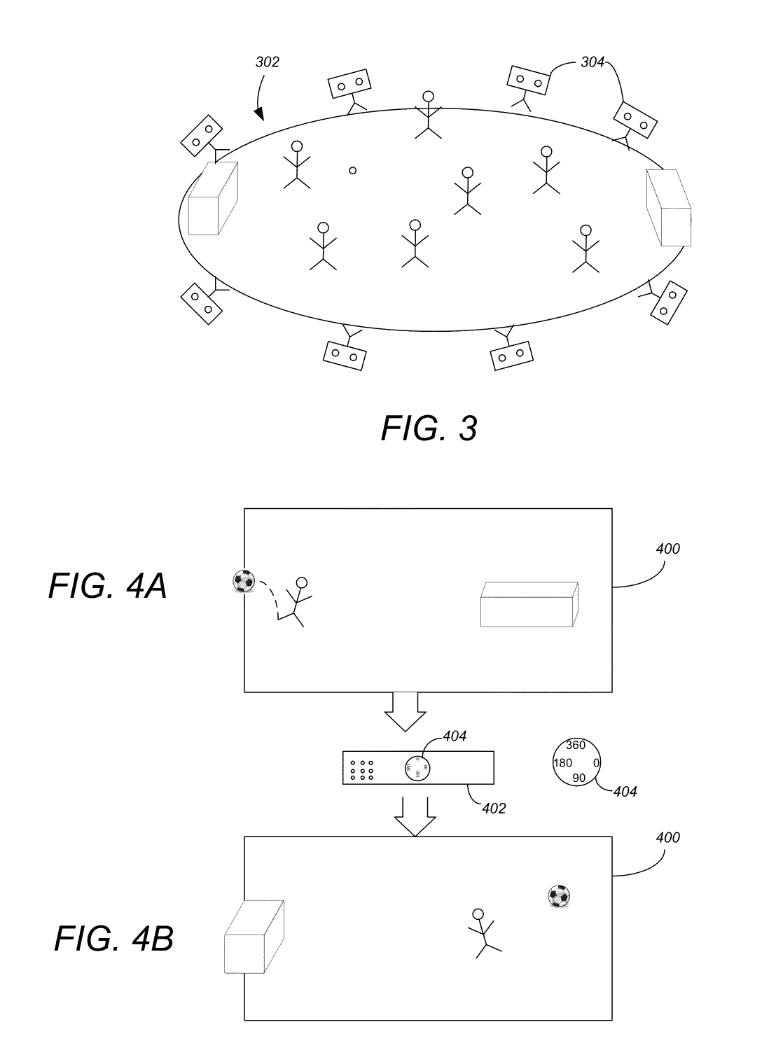

FIG. 3 illustrates an exemplary configuration for capturing multiple views of a scene to enable the rotation of stereoscopic views in accordance with one or more embodiments of the invention. As illustrated, a live action game 302 is in progress (e.g., soccer). Stereoscopic HD cameras 304 are capturing the game from multiple angles.

FIGS. 4A and 4B each illustrate a stereographic display 400 with the same scene viewed in a different angle. The remote control 402 may contain a dial 404 for selecting the angle to watch the scene/game/event. Thus, based on the different cameras 304, the user may select (e.g., via remote 402) a particular viewing angle as illustrated in FIGS. 4A and 4B to view the scene.

### Stereoscopic Object Handling Interface and Interaction Index

Embodiments of the invention enhance the interaction factor between users and virtual objects. It provides a mechanism for designing a new way of interacting with 3D objects and opens the doors for a new class of menu systems that would be operated in a device-free environment.

Embodiments of the invention provide that a stereoscopic object could is handled through a gesture recognition interface. In the prior art, when a user is creating/editing stereoscopic objects, the user uses a mouse/keyboard for that purpose.

In one or more embodiments of the invention, a camera tracks the user's body parts (or only hands), and based on the gestures, appropriate events are applied to a stereoscopic object. In this regard, the user is able to “interact” with stereoscopic objects. Such an interaction is achieved through a combination of gestures and sensors. Further, the user may be required to wear a stereoscopic camera or view the 3D media in a glass-free 3D stereoscopic system.

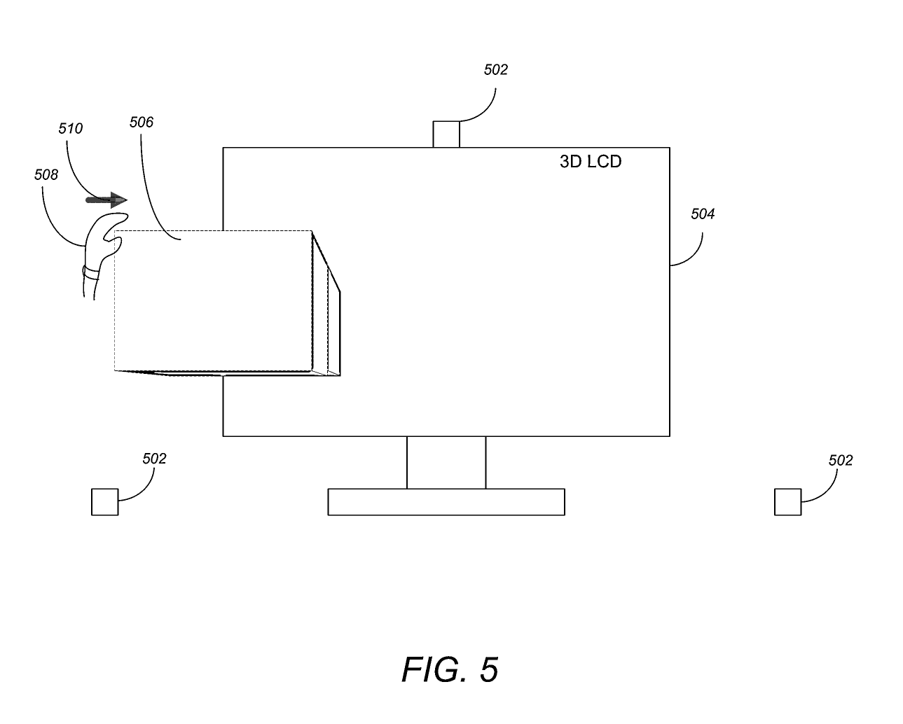

As shown in FIG. 5, three (3) sensors 502 are placed along the sides of the screen (e.g., 3D LCD) 504, which would handle the interaction between stereoscopic objects 506 and the physical user 508. When a stereoscopic object 506 comes out of the screen 504, the software is aware of the coordinates of the object with respect to the plane of the screen 504. Accordingly, if the object 506 is appearing e.g., 10″ out of the screen 504, the software is aware that the object's Z coordinate is (screen Z coordinate+10).

The three (3) sensors 502 on the sides of the screen 504 keep track of where the user's hands 508 are, and convey the information to the software. In other words, the sensors 502 are used to triangulate/determine the exact location of the user's hands/gloves 508. As soon as the user's hands 508 come within a range of interaction with the steroscopic object 506, the sensors 502 pass an event notification to the software regarding the interaction. Accordingly, object 506 represents a virtual stereoscopic 3D object with the dotted lines indicated part of the 3D object that protrudes out of the screen.

The object will move based on the gesture of the user's hand 508, e.g., if the hand 508 moves left, the software may also move the stereoscopic object 506 to its left. This movement is coordinated both by the sensors 502 and/or camera, which keeps track of the user's hand 508 position relative to the screen 504 at any given moment, and notify the software accordingly. The software then keeps adjusting the position of the stereoscopic object 506 relative to user's hand 508 so that the user's hand 508 never breaches the object (or is always able to touch the sides of the object 506). Such position adjustment (and limitations) gives the feeling that the object 506 is interacting with the user 508.

In view of the above, the bold arrow 510 shows the direction of movement of the user's hand 508. The three sensors 502 (infrared, etc.)/cameras determine the exact location of the user's hand 508 with respect to the screen 504 and passes the information to the system. The system then adjusts the position of the object 506 dynamically based on the position of the user's hand(s) 508. If the user's hand 508 moves right, the system updates the position of the object accordingly so that the virtual object 506 always would seem to be “interacting” with the user's hand(s) 508.

Additional embodiments of the invention may utilize an interaction level index, which would be modifiable by the user. So for example the user wants to interact with a virtual object (say a ball), the user can set the interaction index to high, such that when the ball is touched, it bounces back at a high speed. However, when the user is performing a different task, say touching virtual water/smoke/fire, the interaction index could be set to low, so that the user's hands are able to freely move through a semi-solid object (water, smoke, etc), yet the user also gets a feeling that he/she is moving his/her hands through some material. If the user wants to move his/her hands through thicker substance (say jelly or oil), the interaction index may be set to a higher value.

Vast applications of such a feature may be utilized in embodiments of the invention as it would allow the development of deviceless interaction with software. Thus, embodiments provide a new way of interacting with software could be evolved which could see the users working with virtual 3D stereoscopic objects.

In view of the above, one distinguishable feature from that of the prior art (e.g., U.S. patent application Ser. No. 12/480,673, Publication No. 2010/0309197 by Gunjan Porwal filed on Jun. 8, 2009) is that the interaction with stereoscopic objects is active in the present application. In other words, the user is constantly interacting with the virtual object rather than an object only hitting/dropping on a physical object. Accordingly, the embodiments of the present invention provide a way for a user to actively interact with stereoscopic virtual objects, whereas the prior art merely describes a concept of virtual stereoscopic objects interacting with real world physical objects. In addition, unlike the prior art, embodiments of the present invention utilize an interaction index for interacting through different types of material.

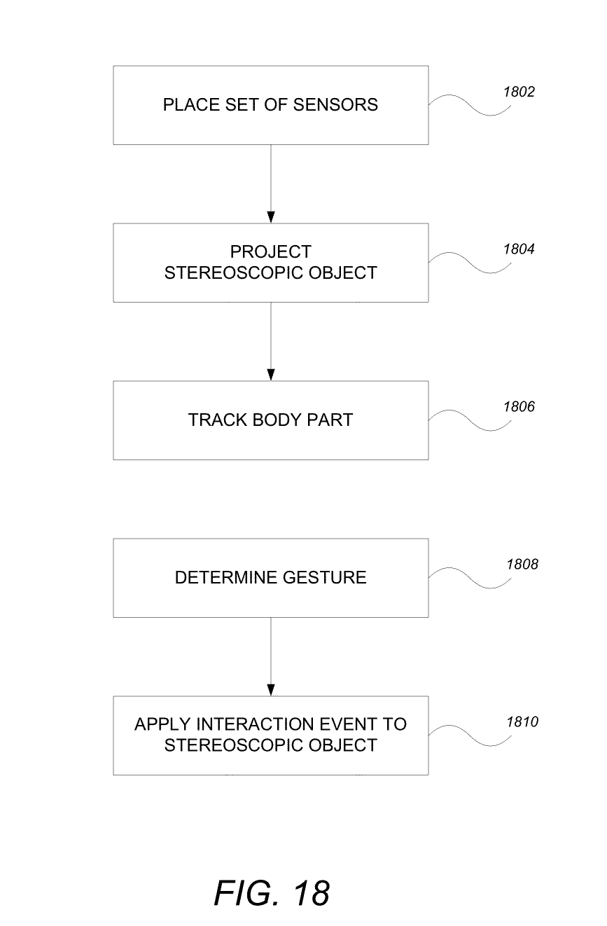

FIG. 18 illustrates the logical flow for interacting with a virtual stereoscopic object in accordance with one or more embodiments of the invention.

At step 1802, a set of sensors (e.g., three [3] sensors configured to triangulate a user's body part) is placed adjacent to a stereoscopic viewing area. Such a stereoscopic viewing area may consist of a stereoscopic camera worn by a user or a stereoscopic screen (e.g., television).

At step 1804, a stereoscopic object is projected in the stereoscopic viewing area. Such a projection may project the object to known coordinates (e.g., a known distance) with respect to a stereoscopic viewing plane.

At step 1806, a user's body part (e.g., a user's hands/gloves) is tracked using the set of sensors.

At step 1808, a gesture of the user's body part is determined based on the tracking. For example, the gesture may include the movement in a particular direction of the user's hands, a rotation, a speed/velocity of the movement of the user's body part, etc.

At step 1810, based on the gesture, an interaction event is actively and dynamically applied to the stereoscopic object. Such an interaction event may include determining when a user's body part comes within a range of interaction with the projected stereoscopic object, and dynamically manipulating the object based on the gesture once within in range. Such a manipulation may dynamically adjust a position of the object relative to the user's body part (e.g., such that the user's body part never breaches the object). In addition, the application of the interaction event may further include defining an interaction level index (e.g., for the object) that determines a level of interactivity between the object and the user's body part. Such an interaction level index may also define a virtual viscosity or type of material of the object.

### Object Manipulation in Stereoscopic Mode

Embodiments of the invention take care of issues of manipulation of objects (such as rotation, translation and scaling) in stereoscopic mode. In normal 3D mode, it is easy to shift pivots of objects and then perform a manipulation with the shifted pivot. Even if the object's pivot is not inside the object, the pivot can be shifted temporarily inside the object (in the center of bounding box of object), the object can be rotated/scaled, etc and then the pivot can be shifted back. However such an operation is not possible in stereoscopic objects because the object itself is located outside the screen, and so the pivot cannot be temporarily be shifted in the object's bounding box center. Such limitations make rotation/scaling of stereoscopic objects a complicated task. Embodiments of the invention attempt to solve such a problem.

During a 3D object design process, it is very routine to be able to review the object from different angles and directions. Any 3D object has a pivot at its center (actually at the center of the bounding box of the object). When the 3D object is rotated, scaled or translated, the manipulation happens around this pivot.

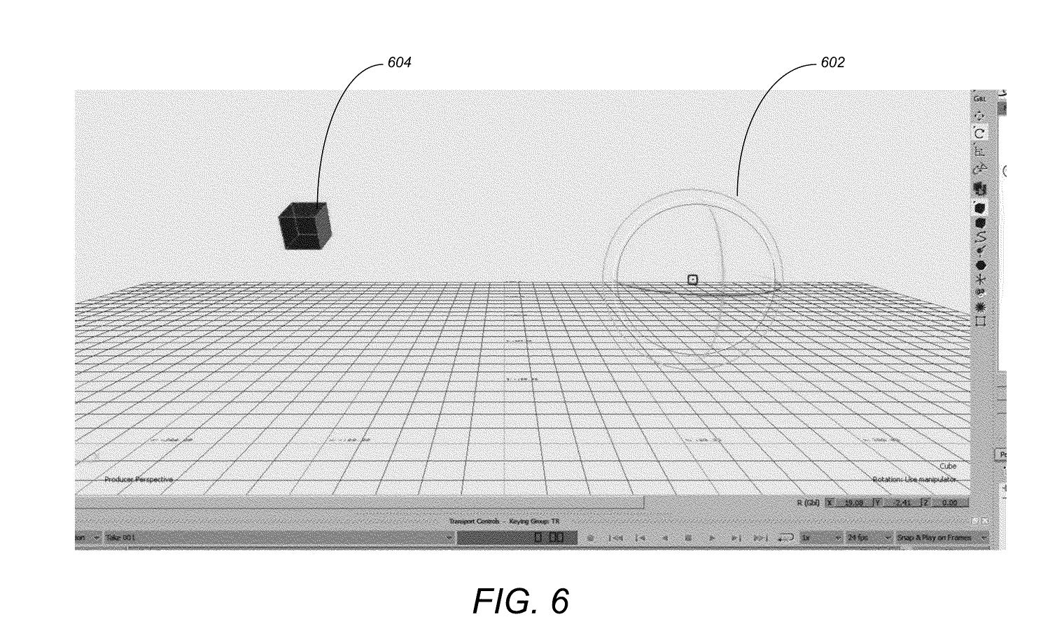

Consider the example where the pivot of an object has been shifted away from the object as illustrated in FIG. 6. As illustrated, the pivot 602 has been shifted away from object 604. If one tries to rotate the object 604, the object rotates around the pivot 602 that is outside of the object (similar to earth revolving around the sun). Thus, it becomes difficult to rotate the object 604 around its own axis. However, the pivot 602 can be temporarily shifted back to the object's bounding box center so that the object 604 can be rotated around its own axis, and then the pivot 602 moved back once the rotation is complete. While such a temporary shift, pivot, and shift back works quite well for 3D objects, it is difficult for stereoscopic 3D objects, because with stereoscopic 3D objects, the stereoscopic object is “outside” of the screen, and the pivot 602 may be inside the screen. Accordingly, when the pivot 602 is temporarily shifted, it would shift in the bounding box of a stereoscopic object (“outside” of the screen). In this case, rotation cannot be done, because the mouse cannot access any coordinates outside the display screen.

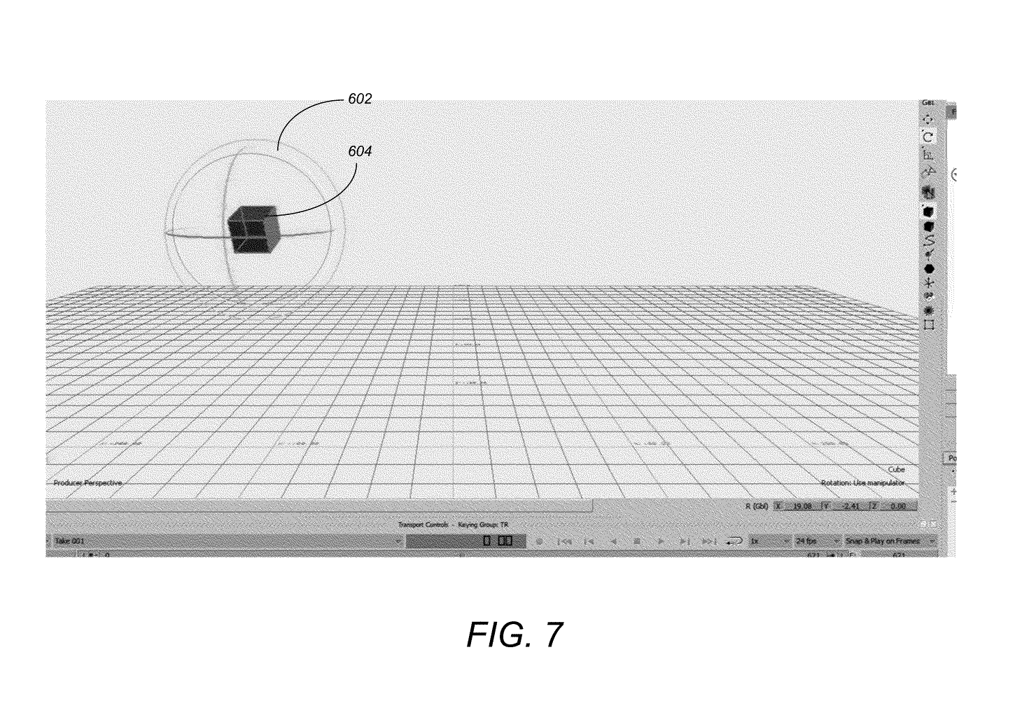

FIG. 7 shows if the pivot 602 of the object 604 is shifted temporarily, it can rotate around its own axis, and upon task completion, the pivot 602 can be shifted back to its original position. In contrast, FIG. 6 shows the example of an object 604 that would rotate around its shifted pivot 602 (like the earth rotates around the sun).

Embodiments of the invention propose that for manipulation of stereoscopic objects, a stereoscopic object can have a temporary pivot 602 mapped in the viewport of the software (such as Maya™/MotionBuilder™/AutoCAD™/SoftImage™) in which the object 604 is being developed/viewed. Thus, as soon as the object 604 goes out of the screen (i.e. it becomes a stereoscopic 3D object), its pivot 602 does not move out of the screen, but remains inside the screen, which would give the user control to rotate/translate or scale the object 604 on its own bounding box center (which happens to lie outside the screen).

Further, if the pivot 602 of this stereoscopic 3D (S3D) object is temporarily shifted from the original position to the object's center (which lies outside the screen), instead of moving out, the pivot 602 just changes its appearance/property.

For example, the pivot 602 can change its color or icon or any feature that represents that the virtual pivot 602 is now at the bounding box center of an S3D object (note that the pivot 602 remains at the same position or shifts to a different position inside the viewport). Rotating the pivot 602 inside the viewport would have the effect of rotating the S3D object about its bounding box center, which is outside the screen. In effect, the S3D object would have a virtual pivot 602 at its bounding box center. Thus, any user would be able to rotate/scale/translate a S3D object about its bounding box center. As soon as a hotkey/button is pressed, the pivot 602 would shift back to its original location and any manipulation would happen around the location of pivot 602 rather than the S3D's object's bounding box center.

The methodology for enabling the pivot/rotation is activated/triggered as soon as the command for shifting the pivot 602 of the S3D object to the bounding box center of S3D object is given (it may be a hotkey or button), the pivot's movements are mapped to the movements of the S3D object. Thus, rotating the pivot 602 by 10 degrees, would rotate the S3D object by 10 degrees on its own axis (rather than rotating the S3D object around the pivot 602 by 10 degrees). Accordingly, all of the manipulations performed on the pivot 602 would be directly mapped to the S3D object.

An example of utility of this invention can be in a large and complex S3D scene where lots of S3D objects are present (consider a Virtual Movie Making scene in a movie like ‘Avatar’ where hundreds of objects are present). In such a use case, the developer may want to pick a particular object and place it at a certain position in S3D mode. To perform such a placement, the developer might shift the pivot 602 of the object. However, as soon as the object turns stereoscopic (i.e. goes out of screen), the developer would not be able to turn the object around its bounding box center. If the developer wants to rotate the object by a very slight amount on its axis, the object would need to be moved back “inside” of the screen where the rotation is performed followed by bringing/moving the object back “outside” of the screen. Such steps would be very cumbersome and tedious for a large number of objects. Enabling the feature provided by embodiments of the invention would help the developer keep the S3D object's pivot 602 at its original position, and also make sure the S3D object can be manipulated around its bounding box center.

There may be additional useful applications of embodiments of the invention in development of S3D objects. When the user is viewing an object in S3D mode (e.g., the user is designing a S3D car), the user may need to see the object from different sides and angles. Rather than rotating and translating the object at different angles to see different sides, the user could simply toggle the pivot so that the user can do the manipulation of the S3D object around its virtual pivot (the S3D object's bounding box center). This would enable the user to rotate/translate/scale the S3D object at is own place. The user can easily rotate the car and see different parts and then later can reset the pivot so that it can again act as a normal pivot (e.g., if the user rotates the pivot, the S3D objects rotates around the pivot).

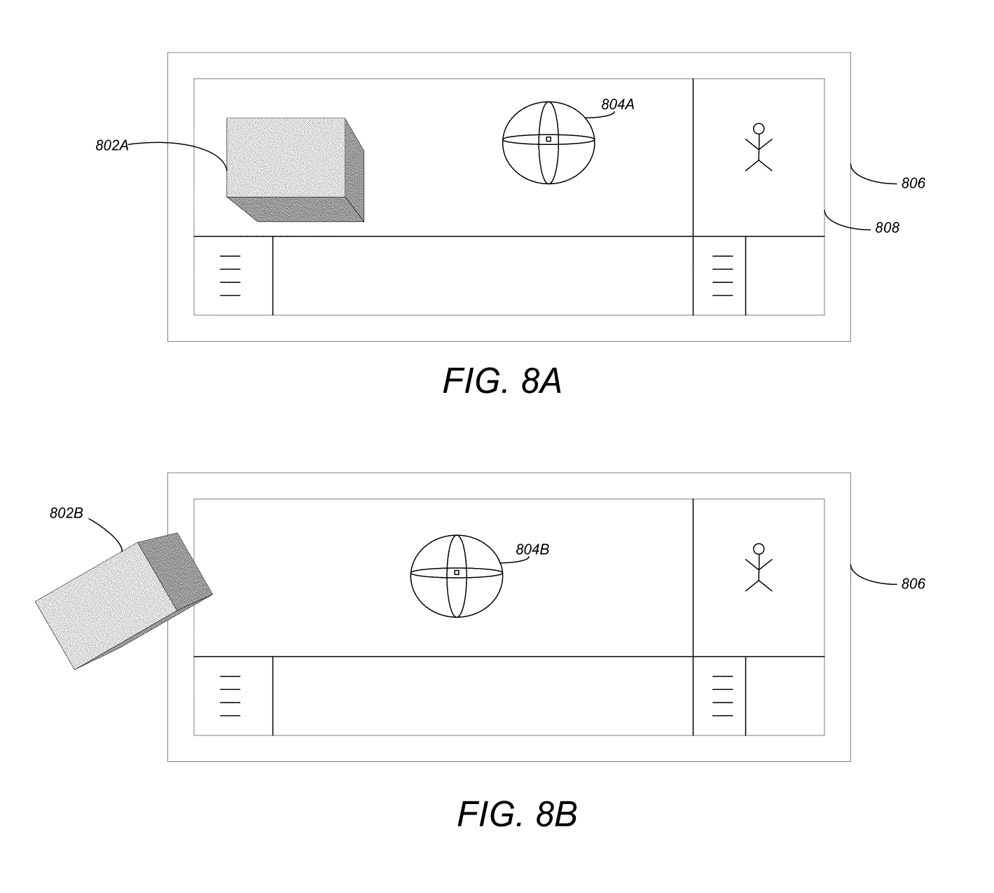

FIGS. 8A and 8B show an example implementation of utilizing a pivot to rotate an off-screen S3D object in accordance with one or more embodiments of the invention. FIG. 8A shows that the 3D object 802A can be manipulated easily by its shifted pivot point 804A for a normal 3D case within an LCD screen 806 by DCC software 808 (e.g., MotionBuilder™, Maya™, etc.). The pivot 804A (of object 802A in rotation mode) can be temporarily shifted to the object's bounding box center.

FIG. 8B shows how a stereoscopic object 802B can be maintained by its pivot 804B. On pressing a hotkey, the pivot 804B can allow transformations to the object 804A around its bounding box center (which is outside the screen 806). This temporarily shifts in the pivot's property can be shown by a change in color or icon of the original pivot 804 instead of shifting the pivot 804 itself outside the screen 806.

Prior art embodiments related only to normal 3D mode where the pivot 804 was temporarily shifted to the object's bounding box center (e.g., as in FIG. 8A).

Accordingly, embodiments of the invention provide a way of direct manipulation of S3D objects, which would otherwise take a large number of steps to achieve.

### Levels of Stereoscopic 3D

Stereoscopic viewing is not equally comfortable for everyone, and some people enjoy watching mild stereoscopic content, while others might enjoy watching heavy stereoscopic content. Embodiments of the invention attempt to solve the problem by introducing a level based mechanism wherein the same 3D stereoscopic content can be played differently at different times for different audiences. The advantage is that different people can have pleasurable viewing experience with the same media.

There is lot of 3D content that is available to users now. However, some of the content is unsuitable for young viewers, or a particular class of audience. A good option would be to classify 3D material so that different classes of audience are able to view it at the same time. Consider an example of a 3D stereoscopic movie being viewed by a family. If the movie has some part having gore, blood or violent content, that should not be viewable by young kids, it is not possible for each viewer to have an option of selective content viewing.

Embodiments of the invention attempt to solve such an issue by proposing a selective 3D content level mechanism. Until now, the user was only able to control the depth of the 3D objects. Embodiments of the invention propose that objects within stereoscopic videos are categorized into different categories. Thereafter, the different object/categories can be viewed selectively by different viewers.

Consider for example a 3D stereoscopic scene involving some explosion scene. The explosion could throw large amount of debris, and this debris could be represented in stereoscopic format. But during the stereoscopic conversion (in movie making)/programming (during game development), this debris could be classified as PG-13, or R. Embodiments of the invention ensures that when such content is played on stereoscopic displays, young audiences, or audiences who do not wish to see too much 3D do not see this debris in 3D.

There are a number of ways this could happen.

As an example, the different levels of 3D may be classified as:
Category 3D-G: Suitable for viewing by all.
Category 3D-PG: Suitable for viewing by young audience under parental guidance.
Category 3D-R: Suitable for mature audience.
Category 3D-V: Suitable for audience willing to watch violent content (such as blood/gore).

If the 3D content is on a Blu-Ray™ disc, the movie would support the above categories. If the viewer chooses the 3D-V category, the user would see all of the violent parts in stereoscopic mode. However, if the user is sitting with his/her family, then the user can choose the 3D-G category, which would render the violent parts in 2D only, and so despite wearing 3D glasses, the viewers would not see any violent part in 3D. In addition, viewers might see other family-friendly parts of the same movie in 3D.

This level of filtering could also be implemented at the TV display level.

Another instance of this invention could be displaying the category mechanism in the stereoscopic glasses. In such embodiments, the user could configure his/her glasses to 3D-V in which case the glasses would enable maximum stereoscopic mode (by passing all the images (Left and Right) of the media. However if the viewer has configured his/her glasses to 3D-G mode (e.g., for children or old people who are not comfortable viewing lot of violence in steroscopic), only select 3D content would appear in stereoscopic, while the rest of the content would appear in normal 2D (e.g., the glasses sync with the Blu-ray™ player or transmission device to figure out which parts of the movie should appear in 2D, and so in those parts, the glasses could pass only a single eye image (either left or right eye image) through both the eye pieces).

Another interesting case may be that for a kids movie, the kids glasses may pass through additional stereoscopic data such as butterflies and bubbles in 3D (in a movie or game), which the parents might not like to have, but is very enjoyable by kids.

In the prior art, (e.g., the Nvidia™ 3D vision kit), one was limited to adjusting the depth of 3D. However, the experience is the same for all viewers and the depth has to be adjusted every time a different experience is desired.

In contrast, in embodiments of the present invention, different viewers can have different viewing experiences while watching the same content at the same time. It could allow for interesting applications whereas some content could be provided only for certain category(ies) of people.

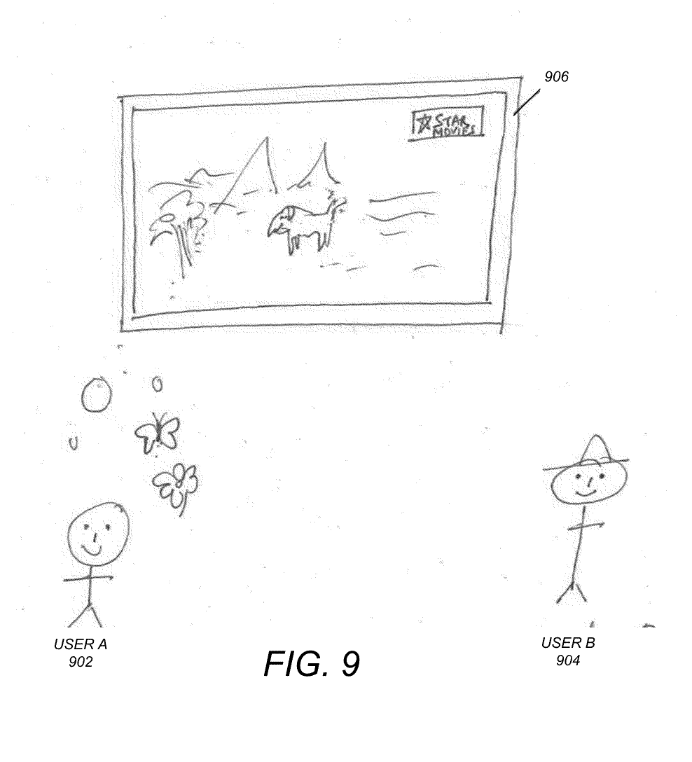

FIG. 9 illustrates an example of different levels of stereoscopic 3D in accordance with one or more embodiments of the invention. User A 902 is a kid that can see butterflies and bubbles in 3D (i.e., on the stereoscopic display 906) since the user's stereoscopic glasses are configured to 3D-G. The kid 902 won't see blood and gore in 3D. Similarly, User B 904 is an adult that sees bubbles and butterflies in 2D since the user has set his/her stereoscopic glasses to 3D-R. The user may also see blood and gore in 3D.

### Using Head-Tracking for Projecting Audio in Lenticular Glasses-Free Stereoscopic Displays

Embodiments of the invention propose a mechanism for projecting audio towards a user by using a head-tracking mechanism in a glasses-free stereoscopic display.

In previous directional audio setups, the audio was only projected towards a single user in only one (1) direction. Embodiments of the present invention allow the audio to change direction based on head-tracking Embodiments of the invention also present a mechanism to create a change in properties of the audio signal (normal home theatre setup) by just detecting the change in user position in front of the screen.

Recent glasses-free stereoscopic displays may use a head-tracking mechanism to keep track of the user so that the display could project stereoscopic images by projecting a left and right image by using lenticular lens. In lenticular glasses-free display, the 3D stereoscopic effect can only be seen in limited zones in front of the screen, known as ‘sweet spots’. The head-tracking mechanism works by identifying the user in front of the TV/mobile display by using computer vision algorithms (face detection or body tracking). A camera is used along with the display (either attached to the same unit, or kept separately), that provides real-time position of the user in front of the screen. Lenticular glasses-free displays have only limited views (e.g., around nine [9]) where the user can watch video in stereoscopic 3D. If the user shifts his/her position from one place to another, the camera updates the position of the viewer, and passes it to the display system. The display uses this information to check if the user has moved from one sweet spot to another. If not, the system may slightly shift the lenticular lens screen so that the user sees a stereoscopic 3D view whichever position the user is in.

Embodiments of the invention propose a mechanism where the user has a system with directional audio integrated with the display such that the audio stream is directed towards the user as the user moves around. This would make sure that the user keeps hearing the audio stream and keeps seeing the 3D stereoscopic display.

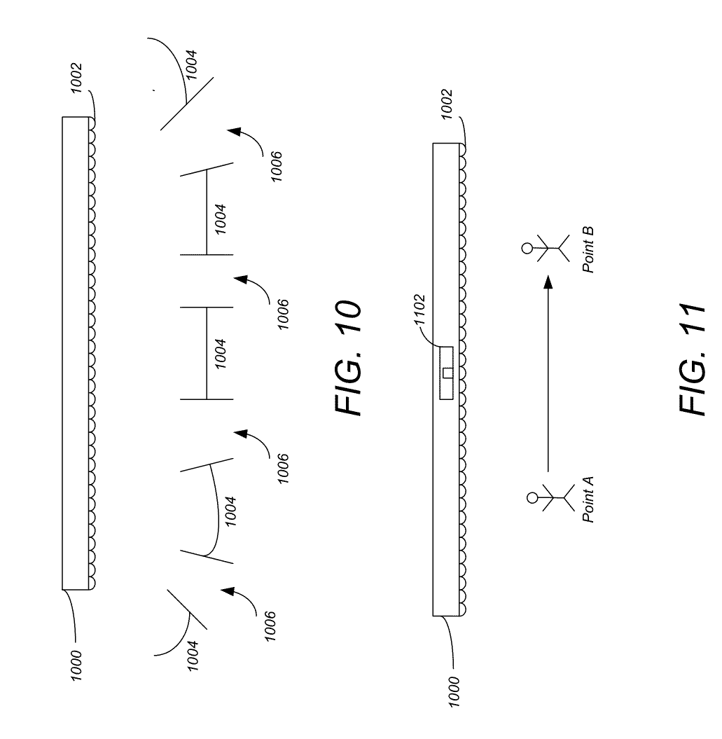

Consider the attached diagram. FIG. 10 illustrates a top view of a stereoscopic 3D glasses free display in accordance with embodiments of the invention. The display 1000 is illustrated with lentiuclar lenses 1002. FIG. 10 illustrates the existence of sweet spots 1004 with no 3D effect for the areas 1006 between the sweet spots 1004.

FIG. 11 illustrates a user changing his/her position from point A to point B. As the user changes position, the lenticular display system (the display screen) 1000 shifts minutely to adjust the field of view. In other words, the camera 1102 tracks the user and adjusts the lenticular screen so that the user sees a 3D stereoscopic display at point B, whether it is a “sweet spot” 1004 or not.

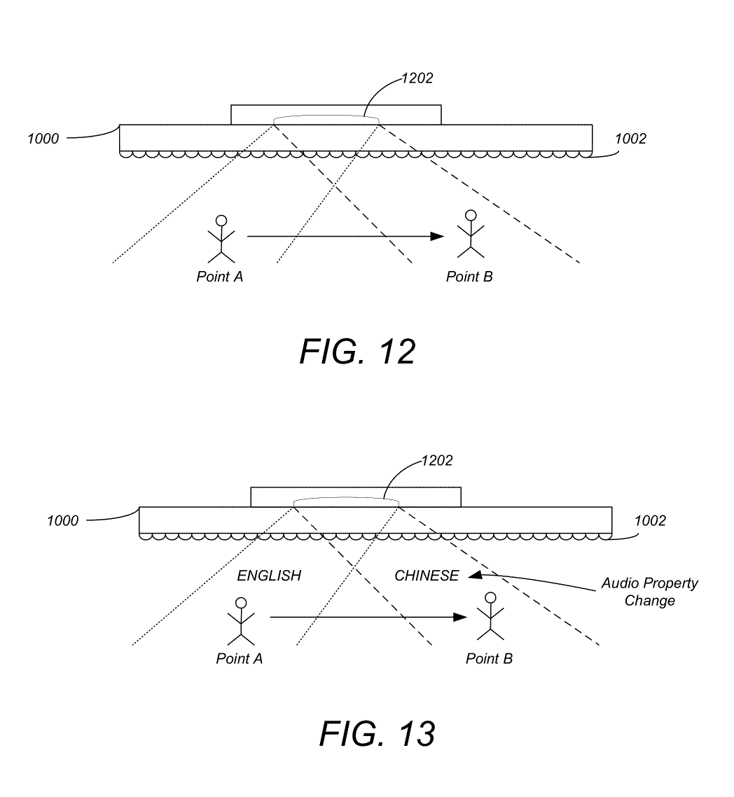

FIG. 12 illustrates a home theater setup that is integrated with a directional audio setup. In such an embodiment, the user position is passed to the directional audio unit (e.g., directional audio sound bar 1202). The unit 1202 rotates the transducer angle to point towards the user, so that the user is able to hear audio all the time. Thus, the direction of directional audio stream changes so that the user does not have to manually set the position of the audio stream. The rotation of transducer may be implemented by a simple pivot mechanism that could rotate it smoothly (similar to rotation of some CCTV cameras). Thus, in FIG. 12, the directional audio stream (from directional audio sound unit 1202) is originally pointing in the direction of Point A. As the user moves from Point A to Point b, the directional audio system 1202 uses the position provided by the camera and rotates the ultrasound transducer to point towards the user (e.g., Point B).

Another embodiment of this application provides for a change in the properties of the audio signal based on the position of the user. FIG. 13 illustrates such a change in audio properties. As a user moves from position A to position B, the directional audio stream can switch the signal from one language to another (e.g., English to Spanish). This can also hold true for normal audio streams, wherein a change in position of the user from point A to point B could convert the audio type from stereo to multi-channel, or from one language to another language. So just depending on the position where the user sits, and the pattern in which he/she switches position in front of the display screen, audio properties or even subtitles could be changed.

In an additional embodiment, the different sweet spots in front of the screen could be associated with different audio properties. For example, sweet spot 1 may be associated with English language audio, sweet spot 2 with Chinese, 3 with German, and so on.

It may be noted that the prior merely has normal audio setups. In prior art directional audio setups, the direction at which the audio was projected was fixed, and so the user had to stay at the same position for hearing the audio.

In contrast to the prior art, embodiments of the present invention provide a mechanism to have a change in the properties of the audio signal based on the position of the user in front of the screen.

### Stereoscopic User Interface

In the prior art, a lot of screen space is dedicated to user interface elements (referred to as UI) that do not get used most of the time. However, it is desirable to have that UI on the screen because it is cumbersome to go to a menu, and open a new window manually. Current product examples include MotionBuilder™ where although most of the UI might not get used frequently, it still occupies screen space. This problem has been beautifully solved on tablets and smartphones with applications such as Sketchbook™ where the UI is hidden and can be brought up with a single tap.

Embodiments of the invention attempt to provide a new way to solve the limited screen space and UI capabilities issue on desktops and future tablets/smartphones.

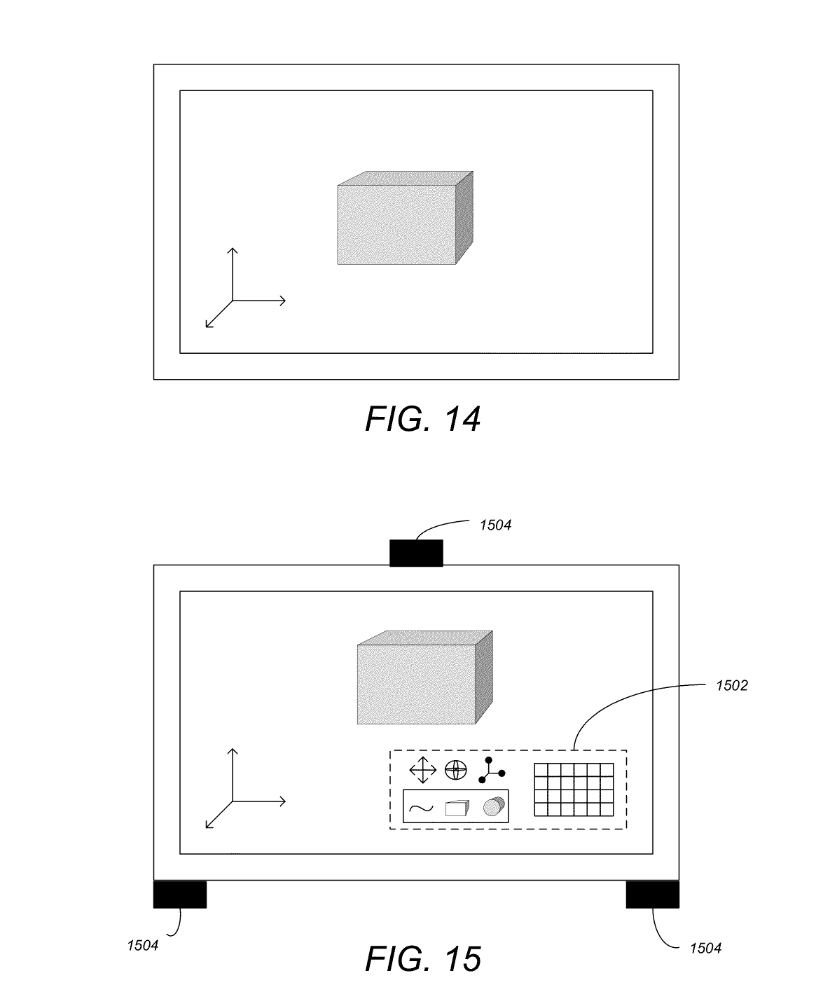

Embodiments of the invention provide for a new UI that is stereoscopic in nature. FIG. 14 illustrates a stereoscopic display with a full-screen viewport in accordance with one or more embodiments of the invention. The user is able to see the viewer or editing screen on the full screen on his desktop or tablet, but the UI is not visible.

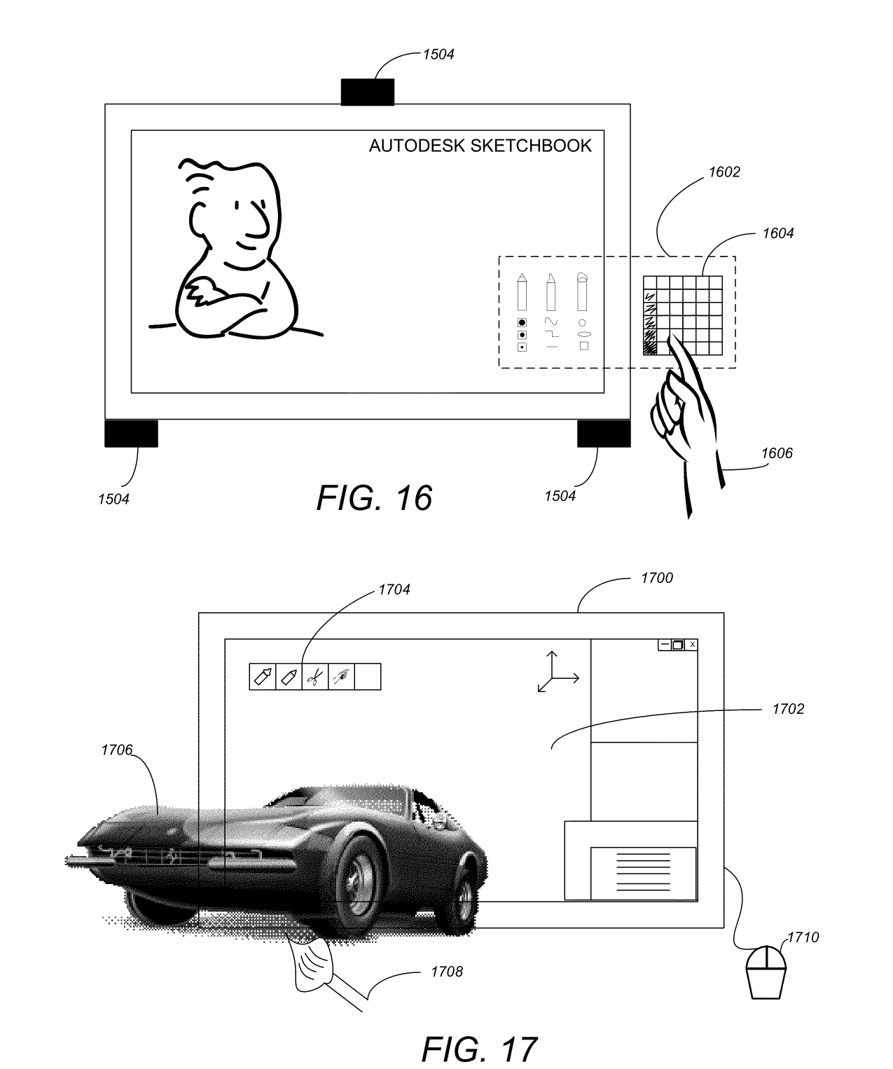

The UI could be visible in stereoscopic mode (FIGS. 15 and 16—the dotted part shows the stereoscopic UI) when the user taps a particular button or presses a hotkey on the keyboard. The UIs 1502 and 1602 are stereoscopic in nature. The interaction with the UI 1502/1602 is made possible through a set of sensors 1504 (e.g., three sensors) that determine (e.g., triangulate) the position of the user's hands 1606 with respect to the projected S3D UI 1502/1602. If the user's hands 1606 touch a particular part of the UI 1502/1602, the corresponding event is sent to the software that would complete the request. For example, if the user touches the brush panel 1604, the sensor detects the user's hand's 1606 position (and it already has information from the software about the layout of the UI), so it determines that the hand 1606 is interacting with the brush part of the UI 1602. It sends an event to the software indicating that the user wants to select the brush mode. Similarly, if there is a stereoscopic color palette and the user touches the color blue, the sensor sends the event that the brush color should be made blue.

The UI 1502/1602 could then disappear from the view when the selection is done, or the hotkey is pressed, or as desired by the user. In this way, the screen remains clutter free and the user gets the full layout of the screen for doing meaningful work. It makes the work of the designer or user easy.

The UI could 1502/1602 could appear with glasses or glasses-free stereoscopic displays. The UI could appear directly in front of the screen, or sideways of the screen or partly in front of screen and partly sideways.

Thus, prior art UIs are limited to within screen 2D based interfaces.

Embodiments of the present invention provide UIs that do not clutter the screen space. Further, users can work with full screen modes all the time resulting in more space and clarity for the user to work on designs and models.

Tools for Modification of Stereoscopic 3D Objects and Saving their Property

Embodiments of the invention provide a new feature of editing stereoscopic properties of an object, and then saving those properties to be referenced later. Such embodiments solve the previous problem that initially 2D and 3D properties of an object were integrated and could not be modified individually.

In various digital content creation (DCC) products, artists, designers and engineers may work directly on stereoscopic objects rather than 2D objects that are projected in stereoscopic.

The work done on these objects may be different from their 2D counterparts. For example, consider the model of a car being displayed in stereoscopic 3D (S3D). The user working on the S3D model might use a tool such as brush or pencil or paint tool (which again is stereoscopic) to make some changes to the model of the car (for example, the user may paint the door of the car with a darker shade than is present—lets say the old color was red and the new color is maroon). Even though the car is being projected from its 2D images (Left and Right images), the changes are saved in a separate file. When the car is viewed in 2D, these changes are not applied to the car model, and so the door appears as the original color (red). However, when the car is projected in 3D, the changes are picked up from the saved reference file, and then applied to the stereoscopic model. Thus the stereoscopic model of the door of the car appears maroon.

Embodiments of the invention provide for stereoscopic tools for modification of stereoscopic objects. So for example, a user working in stereoscopic mode (with glasses or glasses-free) might see a set of tools that the user can pick up virtually (either through mouse, or hand gesture) and then use that on the S3D object.

The tools could be in the form of a paint brush, pencil, cursor, virtual hand, or any other of a variety of different tools. An example could be a virtual stereoscopic paintbrush that could be used to paint a S3D object.

The software knows the coordinates of the S3D object on which the operation has to be done. The software also knows the positions of the DCC tools since both are part of the same operation. Thus, when the DCC tools are moved so that they come within an intersecting/threshold distance of the S3D object, the resulting operation is applied. For example, as soon as the S3D brush ‘touches’ the S3D object, the software starts changing the texture or color of the S3D object to reflect the operation being done by the tool.

Another embodiment of the invention could be that in addition to applying the changes to the stereoscopic model, the change could also be applied to the original 2D model, so that when the 3D stereoscopic model is saved, the change also appears in the 2D model of the car. Accordingly, any change applied to the stereoscopic model filters to the left and right images of the model, and automatically is saved in them.

FIG. 17 illustrates the use of a tool for modification of stereoscopic 3D objects and saving their property in accordance with one or more embodiments of the invention. As illustrated, 3D stereoscopic display 1700 includes various panels and windows. DCC software viewport 1702 consists of the area where the user can perform/create digital content using 3D tools. Panel 1704 is a panel of stereoscopic tools that can be used to edit a stereoscopic object 1706 (e.g., a car). In FIG. 17, a stereoscopic tool 1708 is in action. As illustrated, a paintbrush 1708 is being used to directly paint the S3D object 1706. The user is handling the tool 1708 via a mouse 1710, or other input UI.

Before the above described embodiments, the prior art provided that any change made to only 2D images was applied to stereoscopic objects. Also, only 2D tools were used in the prior art for DCC products. In contrast, embodiments of the present invention provide a method of reverse mapping changes from a stereoscopic model to 2D images of the model. Thus, DCC products are enabled with content creation capabilities in S3D mode. Embodiments of the invention provide various advantages including a way to save and reload changes made to a stereoscopic object both with the changes being applied to only stereoscopic objects and the changes also applied to the parent 2D images.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for interacting with a virtual stereoscopic object, comprising:
placing a set of sensors adjacent to a stereoscopic viewing area;
projecting a stereoscopic object in the stereoscopic viewing area;
tracking a user's body part using the set of sensors;
determining a gesture of the user's body part based on the tracking; and
based on the gesture, actively and dynamically applying an interaction event to the stereoscopic object.

2. The computer-implemented method of claim 1, wherein the set of sensors comprise a set of three or more sensors configured to triangulate the user's body part.

3. The computer-implemented method of claim 1, wherein the stereoscopic viewing area comprises a stereoscopic camera worn by a user.

4. The computer-implemented method of claim 1, wherein the stereoscopic viewing area comprises a stereoscopic screen.

5. The computer-implemented method of claim 1, wherein:
the stereoscopic viewing area comprises a stereoscopic viewing plane; and
the projecting projects the stereoscopic object to known coordinates with respect to the stereoscopic viewing plane.

6. The computer-implemented method of claim 1, wherein the user's body part comprises a user's hands.

7. The computer-implemented method of claim 1, wherein the applying the interaction event comprises:
determining when the user's body part comes within a range of interaction with the projected stereoscopic object; and
when the user's body part is within the range of interaction with the stereoscopic object, dynamically manipulating the stereoscopic object in the stereoscopic viewing area based on the gesture.

8. The computer-implemented method of claim 7, wherein the manipulating comprises dynamically adjusting a position of the stereoscopic object relative to the user's body part and based on the gesture.

9. The computer-implemented method of claim 8, wherein the position of the stereoscopic object is adjusted such that the user's body part never breaches the object.

10. The computer-implemented method of claim 7, further comprising:
defining an interaction level index for the stereoscopic object, wherein the interaction level index determines a level of interactivity between the stereoscopic object and the user's body part.

11. The computer-implemented method of claim 10, wherein the interaction level index defines a virtual viscosity of the stereoscopic object with respect to the user's body part.

12. The computer-implemented method of claim 10, wherein the interaction level index defines a type of material of the stereoscopic object.

13. An apparatus for interacting with a virtual stereoscopic object using computer system comprising:
a stereoscopic viewing device having a stereoscopic viewing area;
a set of sensors placed adjacent to the stereoscopic viewing device;
a computer system having a memory; and
an application executing on the computer, wherein the application is configured to:
project a stereoscopic object in the stereoscopic viewing area;
track a user's body part using the set of sensors;
determine a gesture of the user's body part based on the tracking; and
based on the gesture, actively and dynamically apply an interaction event to the stereoscopic object.

14. The apparatus of claim 13, wherein the set of sensors comprise a set of three or more sensors configured to triangulate the user's body part.

15. The apparatus of claim 13, wherein the stereoscopic viewing device comprises a stereoscopic camera worn by a user.

16. The apparatus of claim 13, wherein the stereoscopic viewing device comprises a stereoscopic screen.

17. The apparatus of claim 13, wherein:
the stereoscopic viewing area comprises a stereoscopic viewing plane; and
the projecting projects the stereoscopic object to known coordinates with respect to the stereoscopic viewing plane.

18. The apparatus of claim 13, wherein the user's body part comprises a user's hands.

19. The apparatus of claim 13, wherein the application is configured to apply the interaction event by:
determining when the user's body part comes within a range of interaction with the projected stereoscopic object; and
when the user's body part is within the range of interaction with the stereoscopic object, dynamically manipulating the stereoscopic object in the stereoscopic viewing area based on the gesture.

20. The apparatus of claim 19, wherein the dynamically manipulating comprises dynamically adjusting a position of the stereoscopic object relative to the user's body part and based on the gesture.

21. The apparatus of claim 20, wherein the position of the stereoscopic object is adjusted such that the user's body part never breaches the object.

22. The apparatus of claim 19, wherein the application is further configured to:
define an interaction level index for the stereoscopic object, wherein the interaction level index determines a level of interactivity between the stereoscopic object and the user's body part.

23. The apparatus of claim 22, wherein the interaction level index defines a virtual viscosity of the stereoscopic object with respect to the user's body part.

24. The apparatus of claim 22, wherein the interaction level index defines a type of material of the stereoscopic object.
